(19) United States
(12) Patent Application Publication
(10) Pub. No.: US 2011/0247259 A1
(43) Pub. Date: Oct. 13, 2011

(54) UNMANNED LAUNCHING SYSTEM AND ASSOCIATED METHOD FOR ATTRACTING WATERFOWL

(76) Inventors: Ryan Toller, Farr West, UT (US); Tracy Toller, Farr West, UT (US)

(21) Appl. No.: 13/082,253

(22) Filed: Apr. 7, 2011

Related U.S. Application Data
(60) Provisional application No. 61/321,755, filed on Apr. 7, 2010.

(51) Int. Cl. A01M 31/06; F41B 11/00

(52) U.S. Cl. 43/3; 124/56

(57) ABSTRACT

An unmanned launching system for attracting waterfowl comprises a decoy body approximating the appearance of waterfowl, and a launcher associated with the decoy body configured for propelling objects therefrom. The unmanned launching system can include a parachute formed from a soft and flexible material, which can be installed within the launcher. An actuator remote from the launcher can be associated with the unmanned launching system, and can operate the launcher from a distance to launch the parachute from the launcher.

### PRIORITY DATA

This application claims the benefit of U.S. Provisional Patent Application Ser. No. 61/321,755, filed on Apr. 7, 2010, which is incorporated herein by reference in its entirety.

### BACKGROUND

Throughout history, sportsmen and hunters have made use of decoys in an effort to lure hunted animals to the hunter. Decoys of various types have proved to be particularly useful for the purpose of attracting waterfowl, such as geese, to a defined location. Typically, decoys are most effective when they closely replicate the behavior of the animal being hunted.

Many waterfowl decoys are static and thus, do not change their position or placement. Some waterfowl decoys are designed for placement on the ground or in the water, while others are aerial in that they are airborne in a manner similar to a kite. Decoys that are static in nature can appear unnatural and thus, may repel live waterfowl rather than attract them.

Live geese are not static, but instead, are dynamic in that they are neither permanently grounded nor permanently airborne. Live geese will often land from flight when they perceive other geese coming in for a landing.

### SUMMARY OF THE INVENTION

In one aspect, the present invention provides an unmanned launching system for attracting waterfowl. The unmanned launching system can comprise a decoy body approximating the appearance of waterfowl, such as geese. The decoy body can be associated with a launcher, which can be configured for propelling objects therefrom. The launching system can also comprise a parachute of a soft and flexible material. In one embodiment, the parachute may be installable within the launcher. An actuator remote from the launcher can be configured to operate the launcher from a distance in order to launch the parachute from the launcher.

In another aspect, the present invention provides a decoy for attracting waterfowl. The decoy can comprise a decoy body approximating the appearance of a waterfowl. In one embodiment, the decoy body comprises a reservoir having compressed air stored therein and at least one parachute. The decoy can further comprise an actuator configured to release the compressed air from the reservoir in order to propel the parachute away from the decoy.

In a further aspect, the present invention provides a method of attracting waterfowl to a pre-determined location using an unmanned launching system. The method includes positioning or installing the unmanned launching system at or adjacent the pre-determined location. The method can further include vacating an area immediately surrounding the unmanned launching system, and monitoring an area about the pre-determined location for the presence of waterfowl. In one embodiment, the method further comprises remotely actuating the unmanned launching system upon the detection of waterfowl in order to attract waterfowl to the pre-determined location.

There has thus been outlined, rather broadly, some important features of the invention so that the detailed description thereof that follows may be better understood, and so that the present contribution to the art may be better appreciated. Other features of the present invention will become clearer from the following detailed description of the invention, taken together with the accompanying drawings and claims, or may be learned by the practice of the invention.

### BRIEF DESCRIPTION OF THE DRAWINGS

FIG. 1 is a side view of an unmanned launching system in accordance with one embodiment of the present invention, shown with parachutes positioned within the launcher.

FIG. 2 is another embodiment of the unmanned launching system of FIG. 1, wherein the parachutes are shown airborne, after being launched from the launcher.

FIG. 3 is a top view of a rotatable plurality of chambers associated with the launcher in accordance with one embodiment of the present invention.

FIG. 4 is a flow chart illustrating a method of attracting waterfowl to a pre-determined location using an unmanned launching system.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modification of the inventive features illustrated herein, and additional applications of the principles of the inventions as illustrated herein, which would occur to one skilled in the relevant art and having possession of this disclosure, are to be considered within the scope of this invention.

In describing and claiming the present invention, the following terminology will be used:

The singular forms “a,” “an,” and “the” include plural referents unless the context clearly dictates otherwise.

As used herein, the term “pre-determined location” refers to any geographic location selected by a user of the unmanned launching system. For example, a hunter might place the unmanned launching system within a pre-determined location comprising several acres of land so that live birds will be attracted to or near such land. In one aspect, the pre-determined location can comprise a geographic locality, substantially all of which can be within shooting range of the position of the hunter.

As used herein, the term “parachute” refers to a piece of material capable of being propelled skyward and forming a canopy such that the speed at which the material falls back to the ground is impeded or slowed. In some embodiments, the parachute can include a weight associated with and suspended beneath the piece of material.

As used herein, the term “unmanned” can refer to the ability of the launching system or decoy to be remotely controlled by an operator who is positioned at a distance away from the launching system or decoy. The terms “remote control” and “remotely control” may be used as verbs and can refer to the ability to control the operation of the unmanned launching system without any physical contact with the system or components thereof. The term “remote control” may also be used as a noun to describe a device which is associated with, but not directly or indirectly coupled to, the decoy and which is configured to control operation of the unmanned launching system from a position removed from the unmanned launching system. For example, a user positioned 50 feet away from the unmanned launching system may use a remote control to actuate the launching system, thus propelling the parachutes skyward.

As used herein, the term “compressed gas” refers to gas maintained in a pressurized condition. Typically, the pressure is greater than normal atmospheric pressure. “Compressed gas” can include compressed air, compressed or pressurized carbon dioxide (CO₂), and the like.

As used herein, the term “substantially vertical” is used to describe a projectile path in which a parachute or other projectile is launched into an airspace above or around a launching system. The term “substantially vertical” can, in some embodiments, refer to a projectile path that deviates from vertical by small or large degrees; however, the end result is that the projectile is launched into the airspace above or around the launching system such that some component of its trajectory is away from the ground on which the launching system is placed.

Reference is made herein to the use of the present invention with geese. It is to be understood, however, that the invention can be readily adapted for use with a variety of fowl and waterfowl, including, without limitation, ducks and similar birds.

With these definitions in mind, reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, which would occur to one skilled in the relevant art and having possession of this disclosure are to be considered within the scope of the invention. Further it is noted that the figures are not necessarily drawn to scale, but rather are drawn to most clearly show embodiments of the present invention.

In some embodiments, the present invention may be drawn to an unmanned launching system and a decoy for attracting waterfowl. In other embodiments, the present invention may be generally drawn to a method of attracting waterfowl to a pre-determined location using an unmanned launching system. Various details are provided herein which are applicable to the unmanned launching system, the decoy for attracting waterfowl, and the associated method of attracting waterfowl to a pre-determined location.

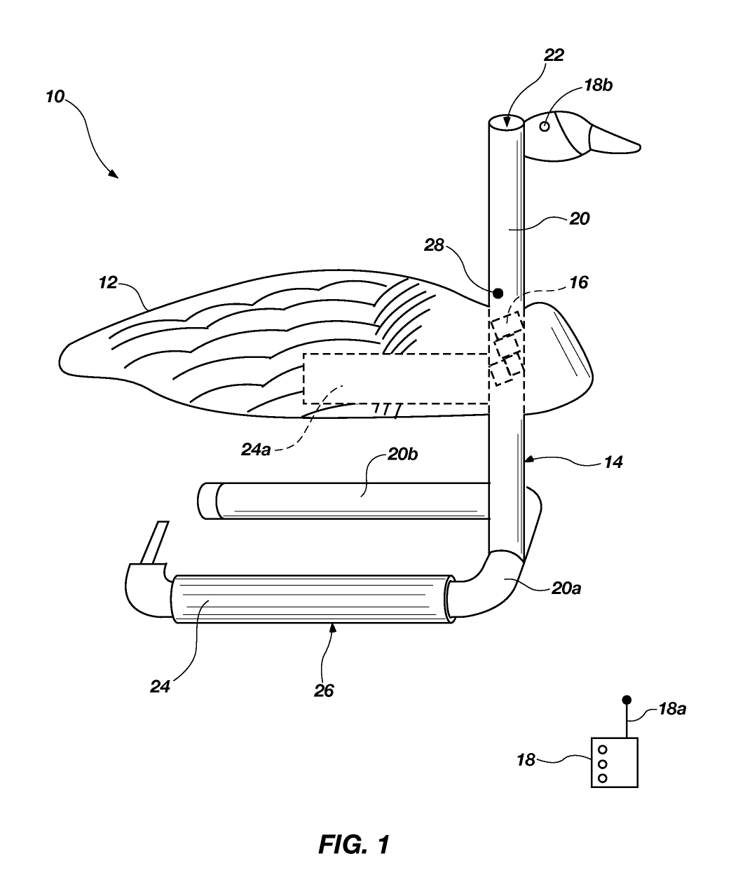

Turning now to the figures, the invention will be described with reference to FIGS. 1-4. The same elements are assigned the same numerals throughout the figures so that repeated description can be avoided.

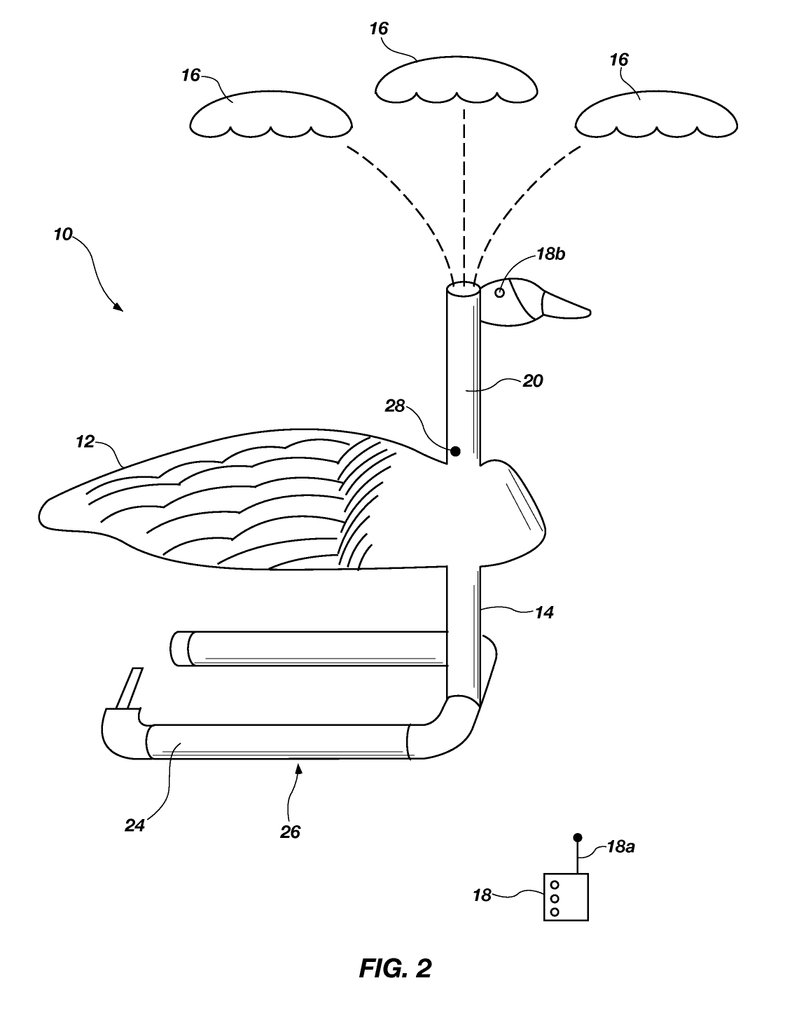

As illustrated in FIGS. 1 and 2, the unmanned launching system 10 can be configured to resemble a live bird, such as a goose. In use, a parachute or parachutes 16 can be stored within or associated with the unmanned launching system and can be propelled from the unmanned launching system when actuated. In one embodiment, the parachutes may have features that result in a bird-like appearance. For example, the parachutes can have a pattern printed thereon that is similar to the pattern on a live bird's wing.

In one aspect, upon being propelled upward and away from the unmanned launching system 10, the parachutes 16 can expand from a folded position, thereby forming a canopy such that they can relatively slowly descend back toward the earth, thus resulting in the appearance of live birds landing on the ground in a location near to where the unmanned launching system is positioned.

In one embodiment, as shown in FIG. 1, an unmanned launching system 10 for attracting waterfowl can comprise a decoy body 12 approximating the appearance of the waterfowl. The decoy body illustrated in the figures resembles a goose; however, the decoy body can be configured to resemble any type of fowl or waterfowl, such as a duck or swan. In one aspect, the body can be formed of a rigid, lightweight, and durable material such as a polyethylene plastic. Polyethylene is known to be able to withstand extreme cold temperatures without cracking or becoming brittle. Materials other than plastic may also be used in some embodiments. In some aspects, the decoy body can be configured to withstand extreme weather conditions since it may be used in a variety of weather conditions, including windy, wet, cold, icy, sunny, snowy, and so forth. The material of the body can have a strength and thickness sufficient to support the launcher associated with the decoy body and any other components associated with or coupled to the body. The body may be shaped and sized similar to that of the type of live goose that a user desires to attract. The body can be formed by injection molding, blow molding or a variety of other manufacturing process known in the art.

In some embodiments, the decoy body 12 may comprise additional design elements or aesthetic features to give the body a more life-like appearance. By way of example, the body may be painted or printed upon. In another aspect, the body may be flocked to give the appearance and a texture similar to or resembling that of feathers.

In a further aspect, the body 12 can have openings (not shown) formed therein so that a user can access an inside cavity of the body. As described herein with respect to some aspects, one or more components associated with the unmanned launching system 10, such as a launcher 14 or parachutes 16, can be positioned and/or stored within a substantially hollow cavity of the body.

As shown in FIGS. 1 and 2, the unmanned launching system 10 may include a launcher 14. In one aspect the launcher may be associated with or coupled to the decoy body 12. The launcher may be configured to propel objects, such as parachutes 16, out of and away from the launcher. As shown, the launcher may comprise a single pipe/shaft, or a network of pipes/shafts 20, 20a, 20b. At least one of the shafts can have an opening 22 therein, through which objects within the launcher can be ejected out of and away from the launcher.

In one aspect, the shaft 20 can be positioned in a substantially vertical position such that parachutes 16 ejected from the launcher are propelled skyward. In another aspect, the shaft can comprise a tilting mechanism 28 which can enable the user to control the trajectory of the parachutes ejected from the launcher 14. While not shown in detail in the figures, the tilting mechanism can be readily incorporated into the launching system by one of ordinary skill in the art having possession of this disclosure.

In another aspect, as shown in FIGS. 1 and 2, portions of the pipes or shafts 20a, 20b can form a base 26 or support upon which the decoy body 12 can be positioned above a ground surface. While the base described herein is comprised of the pipes and shafts associated with the launcher 14, it is to be understood that the base may be independent components, separate from the pipes and shafts.

In one aspect, the portion of the pipes and shafts 20a, 20b forming the base 26 may be removably attached to the decoy body 12 and to other portions of pipe in order to facilitate convenient transport of the unmanned launching system 10. In one aspect, the portion of pipe comprising the base can have a size and weight sufficient to stabilize the unmanned launching system in a substantially upright orientation throughout a launch or series of launches of parachutes 16 from the launcher 14. Once placed in its desired location, the base may be secured to the ground via anchors or pegs in order to provide more stability to the unmanned launching system, especially during a launch

In another aspect, the base 26 can be relatively lightweight such that it can be easily carried and transported by a user. In still yet a further aspect, the base can be hollow and lightweight, making is easy to transport. The pipes or shafts 20, 20a and 20b can be plastic, metal or a combination thereof. Selection of the material composition comprising the pipes may be done taking into consideration a variety of factors including function, cost and safety.

In one aspect, various portions of pipe may be positioned within a hollow cavity of the decoy body 12, and thus not visible by live birds. Other portions of the pipe or shaft 20 may be visible to live birds. In those embodiments in which the shaft is visible to live birds, the shaft/pipe may be painted and/or flocked to give the pipe a life-like appearance resembling the features of live birds. For example, at least one portion of pipe or shaft 20 may be configured to approximate the appearance of the neck of a goose, as shown in FIGS. 1 and 2. In such aspects, the paint and/or flock can be used to approximate the appearance and texture of feathers. In one embodiment, paint and flock may be applied to numerous components of the unmanned launching system 10 in order to give the unmanned launching system goose-like attributes.

The launcher 14 may also comprise or be associated with a compressed gas supply or tank 24 and 24a. In one embodiment, the compressed gas can be a compressed gas such as air or carbon dioxide (CO₂). Compressed gas is well-known and understood in connection with many applications, and one of ordinary skill in the art, having possession of this disclosure, could readily appreciate the use of such material with the present invention. In one aspect, the compressed gas or air supply can be a separate component that can be removably coupled to the piping system. In another aspect, as illustrated by numeral 24 the tank of compressed gas or air supply can be an integral component of the piping system. In still yet a further aspect as specifically illustrated by numeral 24a, the decoy body 12 can include a reservoir or tank 24a having compressed gas or air stored therein.

In use, the compressed gas can be released from the reservoir or tank 24, 24a via a valve or plurality of valves (not shown), thus forcing the parachutes 16 within the launcher 14 out of and away from the launcher. In one aspect, the force of the compressed gas can propel the parachutes up to about 500 feet. In another aspect, the force of the compressed gas may be adjustable so that a user can control the distance the parachutes travel.

In one embodiment, the tank 24, 24a of compressed gas can be associated with a power source and a switch or actuator configured to open and close the valve. When the valve is opened, compressed gas can be released from the tank, and when the valve is closed, compressed gas is maintained within the tank. Any number of known power sources may be used to power the switch associated with opening and closing the valve. In one aspect, however, one or more batteries (not shown) may provide the source of power.

In a further embodiment, the unmanned launching system10 can comprise an activator, actuator or a remote control device 18 configured to release compressed air from the reservoir or tank 24, 24a and actuate the launcher 14 from a position removed from the unmanned launching system 10. For example, the unmanned launching system can comprise a transmitter 18a and receiver 18b in communication with each other. In one aspect, the transmitter and receiver combination may enable a user positioned some distance from the unmanned launching system to remotely control the launcher, including controlling one or more of the frequency, duration and force of the launches.

Transmitters and receivers are well-known by those having ordinary skill and the art. Transmitters generally refer to an electronic device which can promulgate an electromagnetic signal such as a radio or other telecommunication signal. Receivers generally refer to electronic circuits that receive input from a transmitter via an antenna associated with the receiver.

In one aspect a remote receiver 18b can be associated directly with the launcher 14. For example, the receiver may be housed within the launcher and be associated with the switch for actuating the valves that control the release of compressed gas from the tank or reservoir.

In a further aspect, the transmitter 18a can be kept within the possession of the user so that a user can transmit a signal to the receiver 18b associated with the unmanned launching system 10, thereby activating or deactivating the launcher 14.

As referenced above, the unmanned launching system 10 can comprise one or more parachutes 16 that can be propelled out of the launcher 14. The parachutes can be formed of a soft, flexible and or light-weight material. A list of non-limiting examples of parachute materials includes nylon, plastic, silk, linen, canvas, paper, or combinations thereof In another aspect, the parachutes can comprise a biodegradable material. According to this aspect, parachutes that are not retrieved after use may decompose naturally and relatively quickly as a result of the action between the biodegradable material and bacteria in the ground on which the parachutes land. In another aspect, the parachutes may be recycled and reused. For example, after use, the parachutes may be collected from the ground and returned to the launcher for future use.

In one aspect, as shown in FIG. 1, the parachutes 16 can be installed and or stored within the launcher 14. In a further aspect, the parachutes can be collapsible or foldable for placement within an interior cavity of the launcher.

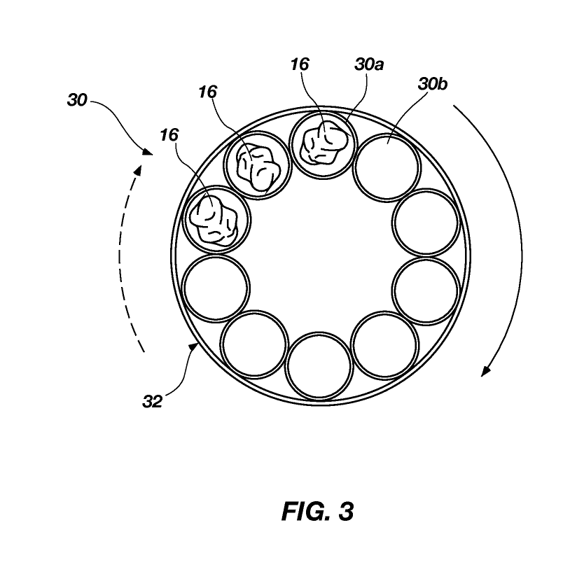

In some embodiments, as illustrated in FIG. 3, the parachutes 16 may be installed or stored within a plurality of chambers 30 within or associated with an interior cavity of the launcher. In one aspect, each chamber can be capable of holding at least one of the plurality of parachutes. These chambers can be directly or indirectly coupled to a substantially circular plate or disc 32. In another embodiment, the chambers can be coupled to each other in a substantially circular arrangement. In use, the chambers can rotate in a substantially circular motion. In one aspect, the parachute or parachutes from one chamber can be propelled from the launcher. The plurality of chambers can then rotate to allow for the propulsion of the parachute(s) from an adjacent chamber, and so forth. In a further aspect, the rotation of the plurality of chambers may be controlled remotely by a user. Likewise, the propulsion of the parachutes may also be controlled remotely by a user.

Upon being propelled from the launcher 14, the parachutes 16 can expand and unfold, as shown in FIG. 2, thus creating air resistance beneath the parachute enabling it to float or descend slowly to the ground. The motion of the parachutes slowly descending to the ground can provide the appearance of live waterfowl coming in for a landing. Upon seeing the descending parachutes, airborne waterfowl may be attracted to the location at which the descending parachutes are landing.

The parachutes 16 can comprise a weight and/or cables (not shown) configured to minimize and control the rate at which the parachutes descend. The use of weights and cables in connection with parachutes will be readily understood by those skilled in the relevant art having possession of this disclosure.

Referring now to the appearance and ornamental features of the unmanned launching system 10, the body of the decoy 12, the launcher 14, and/or a portion of the piping or shafts 20, 20a, 20b comprising the launcher may be machine or hand painted or flocked to imitate elaborate feather details. To further imitate feather details, the surface of the body may be textured rather than smooth, although this is not required. In another aspect, appendages or wings may be added to the body to give a more life-like appearance. Real or synthetic feathers may also be associated with the body and or shaft to further provide the appearance of a live bird.

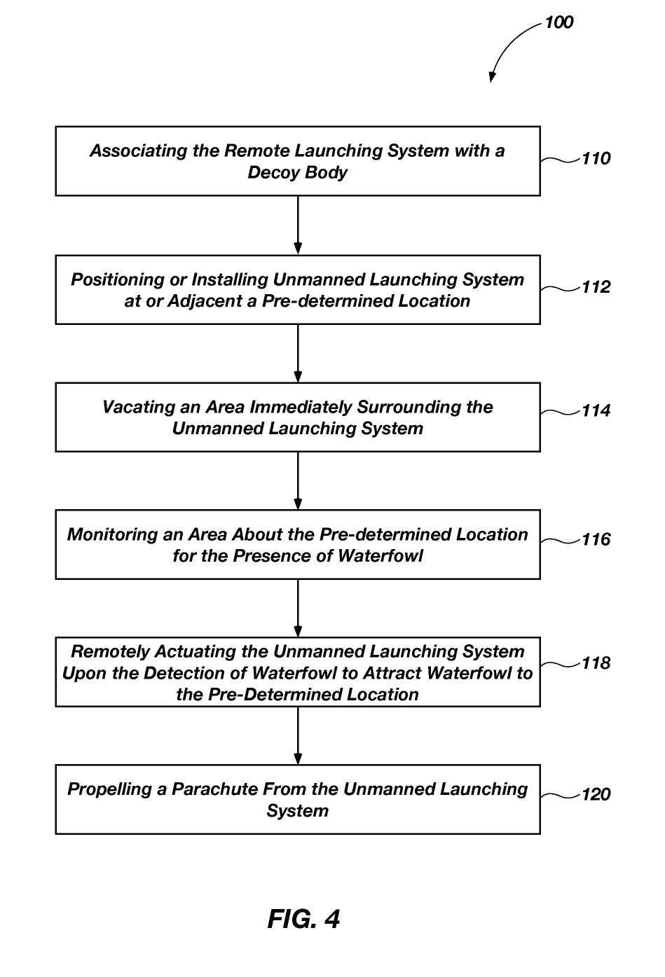

Referring now to FIG. 4, a method 100 of attracting waterfowl to a pre-determined location using an unmanned launching system can include, as shown at 110, associating an unmanned launching system with a decoy body. In one aspect, the decoy body can approximate the appearance of a goose or other waterfowl.

At 112, the unmanned launching system can be positioned or installed at or adjacent the pre-determined location. The pre-determined location can be anywhere, but in some instances may be at or about the natural habitat of the type of waterfowl being sought.

At 114, the method can include vacating an area immediately surrounding the unmanned launching system. When hunting or otherwise attempting to attract waterfowl, it is often desirable for the person (in some cases a hunter) to remain hidden since the sight of a person can scare potential fowl or prey away from the pre-determined location.

At 116, the hunter or user can monitor an area about the pre-determined location for the presence of waterfowl. Upon detection of waterfowl, the hunter or user can remotely actuate (at 118) the unmanned launching system, thus propelling the parachutes from the launching system (at 120) in a substantially vertical direction away from the launching system. The parachutes can then unfold into an expanded position such that air resistance is increased enabling the parachutes to slowly descend to the ground. As the parachutes slowly descend toward the ground, waterfowl may be attracted to the predetermined location.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method of attracting waterfowl to a pre-determined location using an unmanned launching system comprising:
positioning or installing the unmanned launching system at or adjacent the pre-determined location;
vacating an area immediately surrounding the unmanned launching system;
monitoring an area about the pre-determined location for the presence of waterfowl; and
remotely actuating the unmanned launching system upon the detection of waterfowl to attract waterfowl to the pre-determined location.

2. The method of claim 1, wherein actuating the unmanned launching system includes propelling a parachute from the launching system in a substantially vertical direction away from the launching system.

3. The method of claim 1, further comprising associating the remote launching system with a decoy body, the decoy body approximating the appearance of waterfowl.

4. An unmanned launching system for attracting waterfowl, comprising:
a decoy body approximating the appearance of the waterfowl;
a launcher associated with the decoy body and configured to propel objects therefrom;
a parachute formed from a soft and flexible material, the parachute being installable within the launcher; and
an actuator, remote from the launcher and operable to operate the launcher from a distance to launch the parachute from the launcher.

5. The unmanned launching system of claim 4, wherein the launcher includes a shaft having an opening therein, the opening being configured to allow the parachute to be ejected from the launcher.

6. The unmanned launching system of claim 5, wherein the shaft is positionable in a substantially vertical position.

7. The unmanned launching system of claim 5, wherein the shaft comprises a tilting mechanism configured to control the trajectory of the parachute ejected from the launcher.

8. The unmanned launching system of claim 5, wherein the shaft is configured to approximate the appearance of a neck of a goose.

9. The unmanned launching system of claim 4, wherein the launcher includes a compressed gas supply.

10. The unmanned launching system of claim 9, wherein the compressed gas supply is contained within the decoy body.

11. The unmanned launching system of claim 4, wherein the parachute is collapsible for placement within an interior cavity of the launcher.

12. The unmanned launching system of claim 4, further comprising a base configured to stabilize the decoy body in a substantially upright position.

13. The unmanned launching system of claim 12, wherein the base includes a compressed gas supply.

14. The unmanned launching system of claim 4, further comprising:
a transmitter, associated with the launching system; and
a receiver, associated with the launching system and being in communication with the transmitter.

15. The unmanned launching system of claim 4, further comprising a plurality of parachutes.

16. The unmanned launching system of claim 15, wherein the launcher comprises a plurality of chambers associated with the launcher, each chamber capable of holding at least one of the plurality of parachutes.

17. The unmanned launching system of claim 16, wherein the plurality of chambers is rotatable to allow for the successive propulsion of the parachutes.

18. A decoy for attracting waterfowl comprising:
a decoy body approximating the appearance of a waterfowl, the decoy body comprising:
a reservoir having compressed gas stored therein;
a parachute; and
an actuator configured to release the compressed gas from the reservoir to thereby propel the parachute away from the decoy body.

19. The decoy of claim 18, wherein the parachute is formed of a soft and flexible material.

20. The decoy of claim 18, wherein the parachute is formed of a biodegradable material.

21. The decoy of claim 18, further comprising:
a transmitter, associated with the decoy; and
a receiver, associated with the decoy and being in communication with the transmitter.
